(19) United States
(12) Patent Application Publication
(10) Pub. No.: US 2012/0076253 A1
(43) Pub. Date: Mar. 29, 2012

(54) Scalable high efficiency nuclear fusion energy source

(75) Inventor: Fred E. Howard, JR., Fort Walton Beach, FL (US)

(73) Assignee: Mr. & Mrs. Fred E. Howard, JR., Family Living Revocable Trust

(21) Appl. No.: 12/924,259

(22) Filed: Sep. 23, 2010

(51) Int. Cl. G21B 1/00

(52) U.S. Cl. 376/146

(57) ABSTRACT

This invention combines minor, but not obvious, adaptations of available and, for this field, relatively simple hardware that primarily uses the least power-hungry electrostatic (rather than mainly magnetic) control of accelerated colliding beams of bare deuterium nuclei in three-dimensionally pre-determined collision attitudes that are now found by new research to offer a method (with required apparatus) of fusing directly to helium four with high efficiency release of the greatest possible single-step free energy of fusion in kinetic energy of helium four charged nuclei and with minimized side-effects (if any) of wasted energy and troublesome output products in neutrons, radiation, helium three or tritium nuclei, and plasma electrons. This invention can be combined with the most efficient prior art in deuterium ion sources, continued fusion processes, output power conversion, and full reactor assembly at any scale from laboratory experiments to industrial power networks.

### CROSS REFERENCE TO RELATED APPLICATION

Not applicable.

### STATEMENT REGARDING FEDERALLY SPONSORED RESEARCH OR DEVELOPMENT

Not applicable.

### REFERENCE TO COMPACT DISK APPENDIX

Not applicable.

### BACKGROUND OF THE INVENTION

CURRENT U.S. CLASS; 376

CURRENT INTERNATIONAL CLASS: G21

FIELD OF SEARCH: Fusion Reactor, all fields, especially 376

### REFERENCES

### U.S. Patent Documents

| | | |
|---|---|---|
| 3,386,883 | June 1968 | Farnsworth |
| 3,489,645 | January 1970 | Brueckner |
| 4,390,494 | June 1983 | Salisbury |
| 4,390,495 | June 1983 | Salisbury |
| 4,397,810 | August 1983 | Salisbury |
| 4,650,630 | March 1987 | Boyer |
| 4,654,183 | March 1987 | Herschcovitch |
| 4,721,595 | January 1988 | Greenside et al. |
| 4,724,117 | February 1988 | Stearns et al. |
| H446 | March 1988 | Kulsrud et al. |
| H627 | April 1989 | Peng |
| 4,826,646 | May 1989 | Bussard |
| 4,853,173 | August 1989 | Stenbacka |
| 4,894,199 | January 1990 | Rostoker |
| 5,160,694 | November 1992 | Steudtner |
| 5,160,695 | November 1992 | Bussard |
| 5,375,149 | December 1994 | Fisch |
| 5,825,836 | October 1998 | Jarmusch |
| 5,930,313 | July 1999 | Slinker et al. |
| 7,271,400 | September 2007 | Shaban et al. |
| 7,477,718 | January 2009 | Rostoker & Monkhorst |
| 7,719,199 | May 2010 | Monkhorst et al. |

### Other References

Rider, T. H., (1995) Fundamental limitations on plasma fusion systems not in thermodynamic equilibrium, Ph D thesis, MIT.
Bussard, R. W., (1991) Some physics considerations of magnetic-inertial-electrostatic confinement, Fusion Technology 19 (2) 273-293.
Krall, N. A., (1992) The polywell; a spherically convergent ion focus concept, Fusion Technology, 22 (1) 42-49
Ferreira, M. L., (2009) Nuclear Fusion Reactor, www.crossfirefusor.com
Howard, F. E. Jr., (2005) Elementary particle mass sub-structure power law, Florida Scient. 68 (3) 175-205; (2006) Erratum Appendix Table C3 (Typesetter's misprint) 69 (2) 148. (For correction in place see www.electron-particlephysics.org)
Howard, F. E., Jr., (2006) Sub-structure laws of particle masses and charges—a new systematic classification of subatomic particles, Florida Scient. 69 (3) 192-215. (www.electron-particlephysics.org)
Howard, F. E., Jr., (2009) A new paradigm for the unresolved nuclear quarks. (www.electron-particlephysics.org)
Amsler, C., et al., (2008) (Particle Data Group biennial rep't.) PL B 667 (1). (www.pdg.lbl.gov)
Edelman, S., et al., (2004) (PDG biennial rep't.) Phys. Lett. B 592 (1). (www.pdg.lbl.gov)
Wapstra, A. H., Audi, G, & Thibault, C. (2003) The AME2003 atomic mass evaluation (I & II) Nuc. Phys. A 729 129-676.
Stone, N. J. (2000) Table of nuclear magnetic dipole and electric quadrupole moments, Oxford Physics, Clarendon Lab., Oxford UK.
LBL Tables of Isotope Data, etc. (2007) (www.ie,lbl.gov)
Egyan, K. Sh., et al. (CLAS collaboration) (2003), Observation of nuclear scaling in the A(e,e′) reaction at xB>1. Phys. Rev. C 68 014313.
Niyazov, R. A., et al. (CLAS collaboration) (2004), Two nucleon momentum distributions measured in ³He(e, e′pp)n, Phys. Rev. Lett. 92 (5) 052303
Schiavilla, R., et al., (2007), Tensor forces and the ground-state structure of nuclei, Phys. Rev. Lett. 98 (13) 132501
Davies, C., and Lepage, G. P., et al., (2010), Determination of the masses of the common up and down quarks, Phys. Rev. Lett. 104 (2 Apr. issue)
Durr, S., et al., (2008), Ab initio determination of light hadron masses, Science 322 1224
Kronfeld, A. S., (2008), The weight of the world is Quantum Chromodynamics, Science 322 1198
Wilczek, F., (2008), Mass by numbers, Nature 456 449
Bass, S. D., (2007), How does the proton spin?, Science 315 1672
Hasty, R., et al., (2000), Strange magnetism & the anapole structure of the proton, Science 290 2117
Rosner, G., (2000), How strange is the proton? Science 290 2083
Bergstrom, L., and Fredricksson, S. (1980), The deuteron in high energy physics, Rev. Mod Phys. 52 (4) 675-697
Norreys, P. A., (2010), Controlling implosion symmetry around a deuterium-tritium target, Science 327 1208
Glenzer, S. H., (2010), Symmetric inertial confinement fusion implosions at ultra-high laser energies, Science 327 1228
Li, C. K., et al., (2010), Charged-particle probing of X-ray-driven inertial-fusion implosions, Science 327 1231
Clery, D., (2009), Fusion's Great Bright Hope (Laser Implosion), A long winding road to ignition, and What's next for inertial confinement fusion? Science 324 326-330

### CROSS-REFERENCE TO RELATED APPLICATIONS

Not applicable.

### FIELD OF THE INVENTION

This is a basic invention for a fundamentally new type of flexibly controllable nuclear fusion energy source that is not dependent on the high pressure confinement of high temperature gas plasmas or on shock-wave inertial compressions of gaseous, solid, or liquid fuel reactants but, instead, relies primarily on collision in high vacuum of bare atomic nuclei in beams with initial three-dimensional control of the mean relative attitudes and impact angles of opposed bare nuclei in two (or more) oppositely accelerated beams of such ions for optimized high reactivity.

### GENERAL STATE OF THE PRIOR ART

For over a half-century it has been well and broadly understood theoretically, as a result of the prior half-century of physics research, that the observed enormous radiation energy of the sun and other stars is generated by a definite process of fusion of the few lightest atomic nuclei into somewhat heavier nuclei. According to Quantum Mechanics (QM) physics theory, such a process involves some loss of mass energy of the principal reactants to bonding energy in converting into their heavier nuclear particle product or side products. The loss in apparent mass then appears as released energy that is most conveniently measured as thousands or millions, etc., of electron volts (keV or MeV) of kinetic energy of the resulting nuclear or other particles or of emitted radiation energy. This energy released in stars from the fused nuclear particles is always greater by many orders of magnitude (OM) than any ordinary earthly release of energy from chemical reactions by the changes of bonds between electron shells and atomic nuclei of any comparable mass of any sort. Consequently, for about a half-century hundreds of researchers and inventors and their business, educational, and government organizations have been trying to devise ways of making practical human use of the readily available fusion fuels. To date the only thoroughly successful uses are in some QM research tools and the fusion bomb triggered by an only slightly less overwhelming fission bomb. It is hoped by the government investors financing them worldwide that within a decade (or two) one or more of the elaborately experimental billion-dollar fabrications of fusion reactor concepts being pursued will produce significantly more output fusion energy than the required input energy and then may yield a shipboard, rocket, or industrial power plant that is more usable, efficient, and less problematic than the currently installed or foreseen fission reactors. The prospects of this QM advance are not yet bright enough to attract non-government investors beyond a sufficient level of research and invention to stay within competitive reach of government grants and support contracts.

In the meantime the costs and environmental pollutions of the world's main reliance on fossil chemical fuels and wood are becoming more urgent problems under the pressure of growing world populations. In the U.S. these costs and pollutions are now serious political stimuli for finding alternative sources of energy. Hydroelectric power, earth mantle heat, solar energy, sea tidal or wave energy, and wind energy can only make fractional contributions. Nuclear fission power, the only firmly established alternative for the greater part of the energy requirement, is an undesirable fallback for three reasons: The known hazards of lethal and sub-lethal residue releases over wide areas from any reactor accident; the difficulty of preventing the spread of nuclear weapon developments with general use of fission reactors; and the very serious and long term problem of disposing of overly large amounts of dangerously radioactive wastes from fission reactors. Fusion reactors only have the fourth and fifth reasons for avoiding both fission and fusion, the shielded zone of radiation risk which requires rigid safety discipline among highly trained personnel, and the necessity for diffusing away large quantities of residual heat when the temperatures of operating fluids fall below the levels of any effective use.

Reference-documented problems of current fusion technology, some with complicated solutions, include: High plasma temperatures and pressures to obtain gas densities with energy for reactions during long confinement times that permit an adequate rate of fusion events in random particle collisions. Production of troublesome neutrons (also with resultant energy losses) from the most readily obtainable reactions of the readily available fuels (summarized in the references.) Related current emphasis on random collision reactions that produce only fractions of the potentially available energy release that could occur from any previously non-available method of fusing the lightest deuterium fuel directly to helium 4. Neutron damages to reactor structures requiring frequent expensive repairs. Losses in plasma collisions of nuclear particle energy required for bringing fuels up to the energy levels at which fusion occurs. Use of plasma electrons to keep plasmas neutral and more easily confinable, with consequent high losses of “brehmsstrahlung” radiation energy from the electrons. Need to separate plasma electrons from reactive nuclei with added losses from usage of energy in the energy production process. Complexity of generation and focusing of expensive and power consuming laser radiation and other compressors on alternative solid and plasma targets. Complexity, power losses, and costs of magnetic confinement fields. Development risks of much complex and expensive new types of equipment. Altogether, so many heavy losses of power and energy that overall efficiency is low and a significant gain of output over input energy is not yet demonstrated even at inordinate cost for very complex new technology, much of which cannot be utilized except in very large scale installations (requiring further costs for unusually massive power distribution systems over continental areas such as the U.S. On a national defense basis such a commitment to reduced numbers of yet more concentrated and softer essential facilities makes them excessively vulnerable to both stealthy and overt modes of attack in common use.)

### SUMMARY OF THE INVENTION

This invention combines minor, but far from obvious, adaptations of available and, for this field, relatively simple hardware that primarily uses the least power-hungry electrostatic (rather than mainly magnetic) control of accelerated colliding beams of bare deuterium nuclei (deuterons) in three-dimensionally pre-determined collision attitudes that are now found by new research to offer a method (with required apparatus) of fusing directly to helium four with high efficiency release of the greatest possible single-step free energy of fusion in kinetic energy of helium 4 (alpha particle) charged nuclei and with minimized side-effect release (if any) of wasted energy and troublesome output products in neutrons, radiation energy, and helium three or tritium nuclei, as well as minimum interference (if any) by plasma electrons. This configuration and output energy type adapts to most efficient use of the available prior art in output power conversion technology and reactor assembly at either laboratory experiment scale, intermediate single consumer scale, or various levels of industrial power networks. At any scale of operation this invention is inherently suitable for being readily controllable over a range of power outputs, including tuning for peak efficiency at the selected power level and being rapidly turned on or off to meet power needs without wasting significant input power for the scale of operation. (Like other fusion techniques it cannot stand alone. It requires a definite power input to start it, but at a comparatively reduced level of input power for the scale of operation.)

### BRIEF DESCRIPTION OF THE DRAWINGS

FIG. 1 A three part schematic development of the quark structure of a deuteron from that of the proton and the neutron.

FIG. 2 A schematic display of the derivation of the structures of the nuclei of tritium and helium 3 from deuteron collisions in solar plasma and in the prior fusion art.

FIG. 3 A two part schematic of the development of the quark structure of helium 4 nuclei from 3D attitude-controlled collisions of deuterons in the present invention.

FIG. 4. A new schematic collision reactor structure for fusion of deuterium ions directly to helium 4 with each electrostatic control element provided by generic prior technology.

### DETAILED DESCRIPTION OF THE INVENTION

### Introduction on the Deuterium Nucleus to be Fused

It will be helpful in considering the functioning and advantages of this invention, as a new method and general device structure for a high efficiency source of nuclear fusion energy, to have in mind the empiricly necessary physical structure and operational features of the deuterium atomic nucleus. This subatomic particle is also known in the informative references and other literature as the deuteron D, an isotope of the simpler (really simplest possible) hydrogen nucleus (which is a bare proton, p, often H or ¹H, but properly H₁ if its orbital electron charged minus 1 is circling it; otherwise the proton particle is a hydrogen ion with a level +1 of electric charge.) The deuteron is also a +1 charged ion and is often known as hydrogen two (²H, sometimes improperly written as H² {definitely not H₂, which denotes a molecule of two complete hydrogen atoms bound together, each with its one orbital electron, as with its chemical isotope D₂, or in heavy water, D₂O, the universally available source of deuterium as a usual separable portion of ordinary water.}) The essential difference in a single deuteron D or ²D⁺ ion is that it has (approx.) two atomic mass units (AMU) with the same +1 electric charge as the one AMU of the hydrogen nucleus, because the deuteron is made up of a proton (p) with its +1 charge and an electrically neutral (0 charge) neutron (n) bound together by their binding energy of fusion at the lowest level (np or pn). [The QM energy release of deuteron formation by fusing hydrogen and neutrons is rather small, being less than 5 MeV (million electron-Volts) of energy converted from lost mass energy in each of these smallest fusions of just two individual parts. The QM energy release level to be reached under human control in fusing two deuterons directly into a very stable alpha particle or helium four nucleus is about 20 MeV with no losses of energy in undesired particle by-products. (This ideal reaction equation may be written as ²D+²D→⁴He, which output product may also be designated as α or ppnn or pnpn or npnp.) The prior art can only convert deuterons to either ³He (helium three, pnp) or ³H (a tritium nucleus T, hydrogen three, npn) in a single fusion step (for very good reasons noted later), with much less QM energy release, and that energy is in a form that is wastefully difficult to convert to useful electric power. The output of the higher fusion energy to be found in producing an accelerated alpha particle (helium four ion with charge +2) is almost optimally suited for efficient power conversion in the prior available art of the references. Fusing to ⁴He in the prior art requires another wasteful fusion step (and usually a separate reactor installation), though that art often reacts ions by their reactivity in the tail of a lower input energy distribution rather than at most active input energy.] The various names for each of these nuclear particles are interchangeable as convenient or to highlight or remind readers of different relationships in the particles' characteristics. These are important. Such fused combinations of different numbers of protons and neutrons form the nuclei of all the more than a hundred different kinds of other ordinary atomic elements that add to hydrogen and deuterium to provide the material solids, liquids, and gases that make up the perceptible everyday world around us as well as all living creatures in it, including people, not to mention the visible solar system, Milky Way, and starlit universe.

With the help of the complexities of the theoretical QM of nuclear particles, it has been broadly understood in the past half-century that a deuteron consists of the bound pn noted above and that each of these two baryonic types of hadron particles consists of three bound quarks as subparticles. It is the quarks and their forces that bind the fused proton and neutron together as well as binding each of these particles separately and internally so much more strongly that they tend to keep their characteristics as p and n even when forced apart in particle collisions, that is, until a threshold is reached for their additional disruption in even more energetic nuclear collisions. The fusion process considered here does not involve that higher level of disruption of a deuteron in which an n or a p would be destroyed, but the energetic separation of an n and a p from their fusion with each other in a deuteron nucleus is at the core of the next fusion energy release process. That involves the quarks and their binding forces as well as their mass energies.

It has long been broadly understood that there are just two types of common quarks contained bound in the nuclei of every kind of universally observed ordinary matter, especially in stable ordinary matter. [Other bound quarks (and symmetric anti-quarks) than those discussed here appear in other particles in some of the much more disruptive types of particle collisions.] The two common quarks are the very lightest up quark (u) with +⅔ electric charge and the next heavier down quark (d) with −⅓ charge. Charges are measured in comparison with the electron's −1 and the proton's +1 levels of charge. The proton's unit charge adds up from its widely understood uud quarks, as does the neutron's 0 or neutral charge from its udd quarks. But electrons (and some other “elementary” free particles) are not composed of quarks and occur at the unit charge (or neutral) level as independently active particles, while the fractionally charged quarks only occur in bound groups within unit-charged or neutral hadron particles. Hadrons include the baryons, like the most typical p and n, with exactly three quarks and widely varying stabilities (mean lifetimes), as well as the extremely unstable mesons, at less than a microsecond of mean lifetime, with even numbers of quarks/antiquarks summed to unit or neutralized charges.

It has also been long understood that quarks carry the forces of their electric charges (in which like charges repel, and unlikes attract, with forces varying inversely as their separations squared), and that they also bear a more powerful QM “strong” force of mutual attraction, though only at the very close particle separations involved in the two levels of binding. The widely known strong force between udu quarks within the light proton at 938 MeV (rounded) of mass energy, aided by the level of quite concentrated electric attraction of its −⅓ heavy d between its two light +⅔ u quarks at their close internal range, is clearly empiricly able (Howard, 2005, 2006, 2009) to overcome the internal momentums of its mass energy to keep the average proton stable (in a triangular arrangement of its 3 globular quarks in a definite plane with an orthogonal axis) so that protons stay continuously in existence (unless disrupted in the stronger kinds of collisions) far longer than the presently computed life of the Universe. (Edelman et al. PDG, 2004, etc.) The quark strong force within the slightly more massive neutron at only 939 MeV (also rounded), aided by the electric attraction of its light +⅔ u quark between its two heavier −⅓ downs (in its udu triangular plan in a similar plane) is marginally unable to keep the greater internal momentums of an isolated neutron in unstable existence beyond a mean life of less than 15 minutes. Still, when the neutron is stabilized by bound fusion to a proton, each in the triangular arrangement of its three quarks, with the added electric force bonding of three up quarks each to a single opposing down quark between the proton and neutron closely matched in two parallel planes, then the stable mean life of the deuteron (and of its multiple combinations plus an occasional unmatched n or p in heavier stable nuclei) can empiricly cooperate with the free protons & electrons in providing the continued existence of the Universe from near its start to the present. This quite balanced and stably locked matching of rotationally different structures of different p and n masses empiricly clarifies for practical purposes the QM theoretical uncertainty (Bass, 2007) that the spin of the proton (and, by matched opposition in deuterons, the neutron) comes primarily from the sum of spins of the internal quarks rather than from distinctly separate spinning of the entire mass structure of each larger n and p particle. That makes it workable in this invention to control grossly the 3D attitude of each of two colliding deuterons' proton/neutron combination for optimized and efficient fusion into ⁴He rather than that fusion's occurring only in two separate steps of random alignments in energetic plasma collisions.

This partially new and further extended understanding is additionally supported by its general background in a broader overall analysis (Howard, 2005, -6, -9) of the international Particle Data Group (PDG) biennial Summary Lists of the accredited empirical data on subatomic particles (Edelman et al., 2004; Amsler et al., 2008, etc.) This recent analysis found, first, in the original analysis published in a peer-reviewed scientific journal in 2005 (Howard), and again in further analyses of 2006 and 2009 (Howard), that the mass (interaction energy) of a series-base hadron particle mₚ in eV is numericly equal to the sum of the masses of its 2 or 3 quark components Σm_{c} times the exponential law factor N_{c}^{y} of the number of those components raised to the exponent y which varies in a smooth curve from about 0.1 for the very heavy, rarely seen series-base hadrons and quarks to an asymptotic approach to 5.0 near the comparatively light and ubiquitous p and n baryons (or other hadrons) made of their light common quarks, as:

mₚ=Σm_{c}N_{c}^{y} (1)

(where all the component quarks are necessarily charged, though only fractionally charged.)

In the same first 2005 analysis, as well as thereafter, the same y asymptote of 5 was then extrapolated several orders of magnitude along the curve of y to its limit in the area of the possible much lighter sums of masses of any decades-long-sought QM components of the PDG empirical “elementary” particles. These include the electron (a light lepton at a rounded 0.511 MeV in mass rather than many hundreds of MeV like the proton or neutron baryons, etc.), and also all the six massive quarks themselves. The quarks range from 1 to 8 MeV, with ±30-50% PDG uncertainty, for the common lightest up and down quarks/antiquarks, to less uncertain 70 MeV to 5 GeV for three less-often-seen collision-generated quarks/antiquarks, to much more than 100 GeV of mass energy for the ultimately heavy and extremely rare top quark/antiquark.

This analytic approach found in the initial quark-to-hadron exponential law of masses equation (1) a more fundamental power law of masses and charges (2) with a new universal microquantum component of mass for the leptons and quarks that interactively generated the PDG empirical masses of the supposedly “elementary” particles very well (Howard, 2005), as:

mₚ=Σm_{c}N_{c}⁵[(n_{±}/n)+(n₀/an)], (2)

where (n_{±}/n) is the ratio of the number of charged pairs of component microquanta in the particle to its total number of pairs of microquanta and (n₀/n) is the ratio of the number of neutral pairs to its total number of pairs, N_{c}=2n, the number in the particle of individual universally uniform mass microquanta that are all charged either positive or negative ⅙ (not neutral), and Σm_{c} is the sum of masses m_{c} of microquanta in the particle (that also equals N_{c}m_{c}, thus this power law exponent may collect terms to become 6), with m_{c} at 10.9525 rounded eV calibrated for 6 all negative microquanta in 3 charged pairs in the unique electron, while a accounts for the empirical observation that neutral pairs of such microquanta are much less effective interactively at generating interactive mass energy than are charged pairs, so that a equals 3 in this usual range of lepton and quark masses (but equals powers of three in more extreme ranges of electron neutrinos and of cosmic neutrinos that have multiply collided {or oscillated} in transit from star explosions before arriving at earthly detectors.) This law fits the empirical data uniquely well.

It also became clear from the shapes of the empirical curves of data (Howard, 2005, etc.) not only that the quark masses are dependent on the charged and neutral states of pairs of interactively spinning and orbiting charged microquanta moving as paired individuals (unmixed) within roughly globular but linked separate quarks, but also that the quark spins and primarily externally reactive charge forces must necessarily sum forces and effects arising from these microquanta, as must the primarily internally reactive strong (and weak) forces. [Thus numericly integrated forces are also directly computed on perfectly symmetricly balanced and precisely simple electrons with their proton-like long mean lives (as on anti-electron/positrons), from a system of 17 scaling equations and experimental data for symmetric configurations of microquanta posted on line with the Howard references. And forces are estimatable on less symmetric and more complicated light quarks/antiquarks (for summing in hadrons) pending a much larger lab program for more of the quasi-infinite range of asymmetricly arranged quanta.]

The mass-controlling feature of the mass/charge power law (2) is the rythmicly cyclic series of numbers (Howard, 2006) of charged or neutral pairs of separately spinning, but highly interactive, microquanta necessarily moving orbitally in the globularly shaped leptons and quarks. This cyclicity of the numbers of microquanta in particles is especially important in confirming that the earlier PDG 30 to 50% uncertainty in the lighter common quark masses was more accurate in one sense than the 2010 QM theoretical finding (Davies and Lepage et al.) of a single low end mass at low uncertainty for each common u or d quark, since that larger uncertainty (Amsler, C., et al., 2008; Edelman, S., et al., 2004) approximated two exact masses for each quark, one (less common) near the high end of the uncertainty and one (very commonly occurring) near the low end (Howard, 2005, -6, -9). These dual exact masses for each quark are empiricly both necessary and sufficient [and defined under the mass/charge power law (2)] to account for the four or six or eight cyclic steps (when involving one, two, or three different types of quarks respectively in the three quarks of each baryon) which are found to be systematicly present in the series group masses of each of the many famously proliferated baryon series (now reclassified in this manner. Howard, 2005, -6, -9.)

The mass/charge power law equation (2) (derived from PDG empirical data) defined an exact (though rounded) mass of the lightest common up quark and of the next heavier common down quark (Howard, 2005) five years in advance of the 2010 (Davies and Lepage et al.) QM theoretical finding of the single masses to three significant figures ±7% and 3.3% respectively, with the 2005 up quark value within the 2010 error bounds and a deviation in the down quark values of 6.3%. These QM confirmations of the 2005 findings compare with the prior PDG empirical uncertainties of ±30 to 50% on both quarks, depending on the reference number chosen for the divisor, and with the prior QM theoretical statements only of mass ratios for the quarks. (Edelman, S., et al., PDG, 2004, included notes on quarks.)

The 2005 (Howard) empirical ordering and classification of the p and n baryons among their two proliferated baryon series by the exponential mass law (1) of their quark components also anticipated by three years the impressive and much-heralded (Wilczek, 2008; Kronfeld, 2008) QM theoretical calculation (Durr et al., 2008) of 12 individual (series base) hadron masses, and also previously gave the exact and separate ordered numerical mass values that are consistent with the PDG empirical measurements for p and n rather than the (Durr et al, 2008) determination of a single unseparable N (nuclear series) base value for these two important particles. The 2005 (Howard) mass law equation (1) also numericly ordered and confirmed masses for the same 12 hadrons, and 4 in addition, in a single general equation as an effective computation. [The 2005 determination and classification of the primary isotopic group series of the two nuclear neutral and positive baryon particle series (based on n and p), indicating isotope variations of the 6 primary group-leading particles in each of the two series (with a round dozen members each), were then extended by empirical calculation (from the new empirical law and particle classifications) for all individual members of all PDG-accredited baryon series and of the Light Unflavored Meson series, and the data tables are posted on line (Howard, 2009) (wherein there are many other striking correspondences of this empirical particle paradigm with QM.)]

The belated QM theoretical confirmations of major features of the empiricly derived basis for the present invention in particle equations (1) and (2) show the 2005-9 paradigm to be a viable companion with QM and confirm by that correlation the analytic empirical approach which leads directly, if not unavoidably, and if not yet in every QM detail as the paradigm develops further, to the entirely practical, and yet generally new, invention concept.

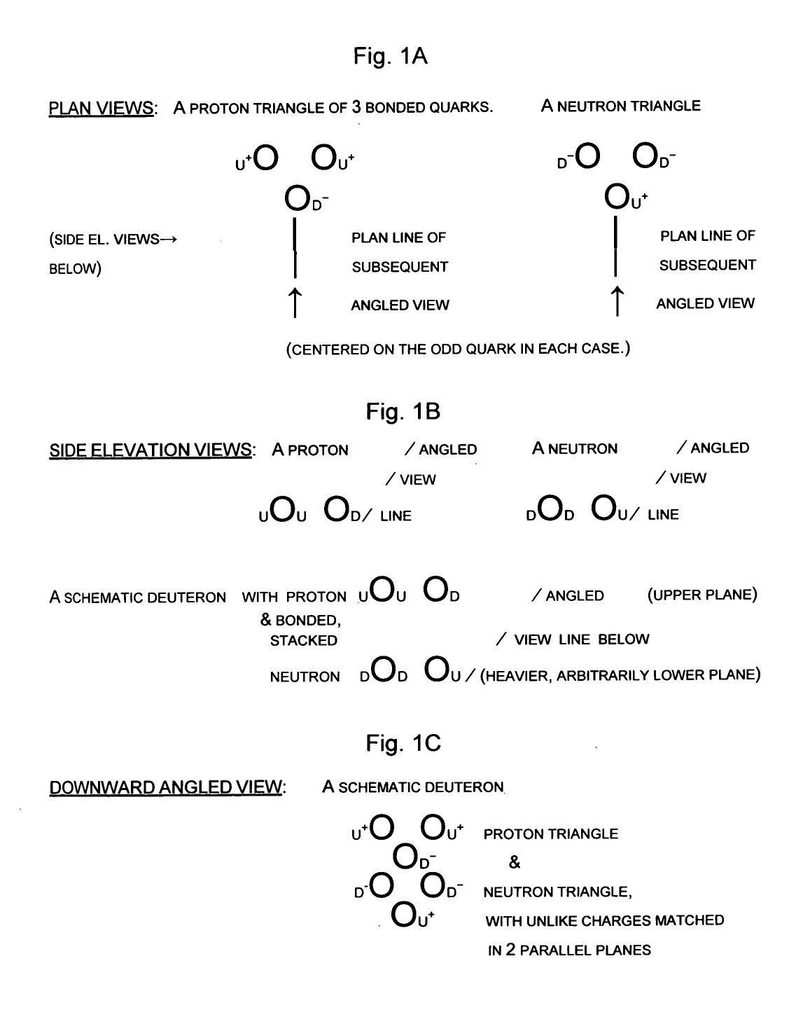

Accordingly, a proton is made up of 3 roughly globular quarks whose centers are in an equilateral triangle that (as in Euclidean geometry) defines a reference plane of their action as seen in FIG. 1a in a schematic plan view beside the plan of a neutron. [For this purpose (as in Howard, 2005) there is no requirement to define whether each quark globule is a perfect sphere (though in Howard, 2009, etc., one linking orbit of a pair of microquanta must necessarily extend beyond each quark sphere for a quark to exist, with the co-function of linking quarks in certain organized particle groups). Nor is there a requirement to define whether the three quark globules are about the same size and separated or in contact with each other (as they are in the further developed Howard, 2009)]. For clarity here, similar schematic quark globules are shown well separated in every plan, side elevation, and downward-angled schematic view. The downward-angled line of observer's 3D projected view is indicated in the initial FIG. 1a plan and FIG. 1b side elevation schematics of the proton and neutron triangles of three quarks each.

A deuteron is made up of 6 globular quarks in these 2 bound, precisely overlaid baryons, each in its own planar triangle in one of two parallel and clearly separated planes, as shown schematically in the lowest side elevation view of FIG. 1b and in the downward angled view of FIG. 1c. Note in FIG. 1c that with their attractions between matched unlike charges in the quarks the two kinds of positive and negative electric charges in the two baryons guide the final bonding by the strong forces between the quarks.

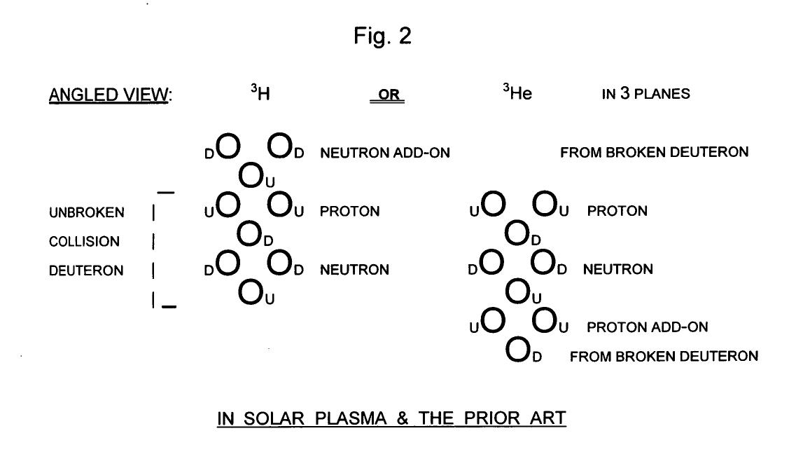

Here each globular quark is link-bonded with the oppositely charged quark directly above or below it in the other baryon triangle, as well as more strongly with the other two quarks in its own baryon. When two of such deuterons collide with each other in random attitudes with enough relative kinetic energy (velocity or temperature), as in the usual hot plasma of the prior fusion art, the one deuteron which happens to be a little more pre-excited than the other by prior actions (loosening baryon bonds) may be broken into separated baryons that go flying off in separate directions that depend on the details of the collision. If one of the two separated baryons happens initially to be not only very close to the other type of baryon in the deuteron that does not break up, but also in the right attitude for guided bonding, and also not moving away too energeticly, then it may lock on with the strong force as guided by the added attraction between unlike fractional electric charges between the quarks. In that case, some mass energy is lost [per a negative value of y in equation (1) due to limited weakening of quark microquantal linkage interactions within baryons with reaching between baryons (FIG. 8, Howard, 2009)]. This yields more kinetic energy of the new particles or radiation. There can result either a hydrogen three nucleus (tritium nucleus or triton) with the same +1 electric charge as the unbroken deuteron had before, or a helium three nucleus with +2 charge, depending on whether it was the separated neutron or proton (respectively) that happened to do the re-bonding after separation as biased by details of the collision. Then the schematic diagram of the principal result of the prior fusion art, all in accordance with the applicable mass laws [(1) & (2)], will be in one of these alternates as shown in the downward angled view of FIG. 2.

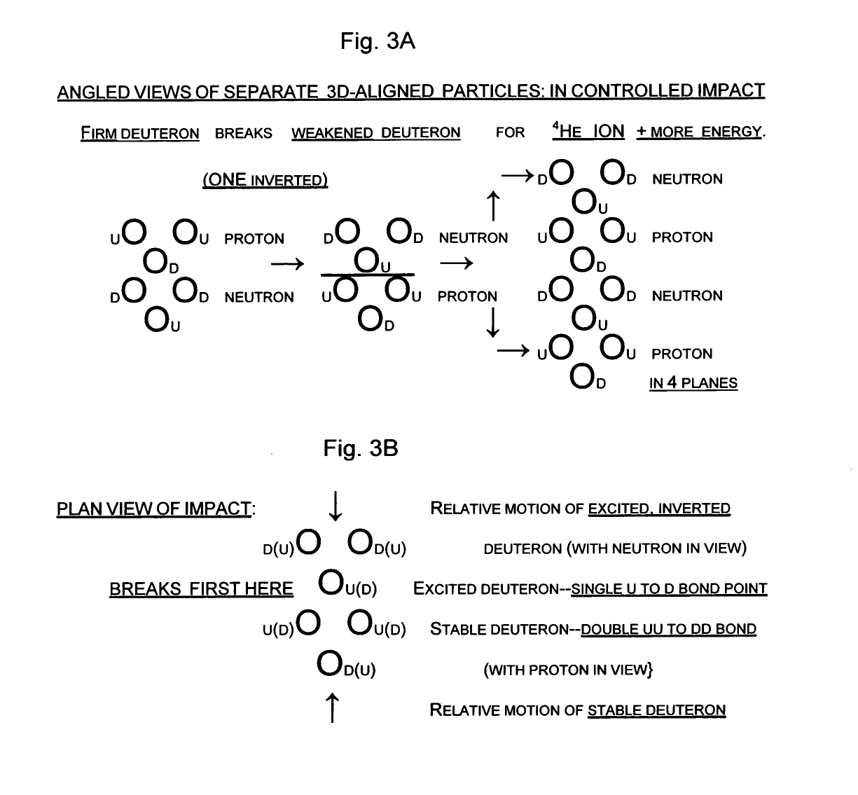

The objective of the present invention is to invert and align one set of half the original deuteron nuclei with respect to the other set in a different opposing beam of deuterons, and to pre-excite one set before the sets intermingle in individual collisions and near misses, so that both the baryons separated by any collision will be at once in the best positions for bonding to the unseparated deuteron with the release of much more mass energy to kinetic energy of a resulting schematically bound ⁴He nucleus than with ³He. These appear schematically as angled views of the separate particles going through the impact and re-bonding process together in FIG. 3a to yield a new type of result in a helium four nucleus with a much greater conversion of lost mass energy to released kinetic energy of the final ion than can occur in the generation of tritium or helium three nuclei in the usual random solar plasma or prior art of fusion.

[This factor of increased energy release in a single step if any fusion of two deuterons directly to helium 4 occurs is in accordance with the interactive mass energy laws (1) & (2) and with the extension of (1) into the component baryons-into-nucleus bonding step with a small negative exponent there as shown in FIG. 8 of Howard (2009).]

A plan view of this encounter in FIG. 3b shows the further point that the predicted best relative attitudes bring the double uu to dd bonded side of the two triangles of the more tightly bound deuteron into impact with the single u to d bonded triangular point of the more loosely bound pre-excited deuteron in initial near mean coplanar attitudes. Here the quarks shown in ( ) are for the baryon in the plane below the top plane of the deuteron double triangles about to collide:

In the FIG. 3b result that weaker single bond will effectively break first, with its neutron's single u quark repelled away from the break by the still bound proton's dual uu side (that is bonded to the bound neutron's dd side) and with the same repelling-away effect on the single looser d point from the double dd side, thus angling the looser deuteron's halves open to slide effectively with their impact momentum above and below the bound deuteron into best alignment for the re-bindings in ⁴He. [[Between two such prepared and opposed deuterons in an impact if their triangle planes are not well aligned within the range of spread of the loosened single bond it may be that this repulsion effect opening the separation of the less bound baryon pair also reduces the impact's cross-section enough that this is not the most productive relative attitude or condition. In long term practical use the largest mean reaction cross-section may even result from reversing this selection of the particle to be excited, or even from colliding with both particles being impacted on the dual-bond sides of the triangles or on the single-bond points (with or without inversion of the particles of one beam or significant pre-excitation or with some small offset of the impact angle), so that the separated baryons are flipped into final bonding positions by the collision impact. In fact it may result that the increased electric attraction between unlike charges with the inverted impact on both double bond sides will increase the impact cross section so much that the second roll attitude control discussed below should be reversed for one set of particles to obtain this alternate impact attitude, and further that the reaction might then benefit from a higher impact energy for the greatest production of ⁴He per number of deuterium ions, and the exactness of relative beam direction angle required should be less critical. (However, most direct alignment in this manner would require in each loosened and re-bonding baryon either an internal flip of the internal synchronization of its quarks' microquantal orbits and their summation axis {Howard, 2009} or an extra 180 degree rotation in transit before rebonding, and these actions are considered much less likely than the simpler indicated alignment above. The stringency of the control angles and conditions for fusion of deuterium directly to helium four accounts for the lack of detection of this direct reaction in nature and the dependence in the prior fusion art on the much looser two-step process through helium three, or even involving tritium {which prior lower quality processes could also be made more productive by the obvious applications of the present newly invented technology.}) The greatest generality of this invention concept is that it provides means and method for controlling and tuning the mean deuteron impact attitudes and energies, with obvious variations, for the largest reaction cross-section found by empirical optimization tuning in use.]]

This overall deuteron configuration in fusing to helium four is confirmed by the sequence of PDG spins of the particles. The QM spins of the p and the n are both ½, so that the intrinsic spin of the deuteron is 1, but the inversion of one deuteron to give the relatively inverted attitudes of the immediately re-bonded components of the excited deuteron cancels the spin of the other more stable deuteron, causing the known spin 0 of the ground-state ⁴He nucleus (LBL nuclear data postings reference). (Thus the alternated baryons in ⁴He shown above also make possible additional extended bonding with longer bond lengths between these nuclei in extended chains near absolute zero temperature with coaxial confinement of the atomic electron orbits, which can account directly for the peculiar liquid characteristics of supercold ⁴He atoms.)

The exactly matched bonding here of unlike charges between each pair of parallel-plane triplets around the matched triangles adds to the strong force in creating the special stability of this ⁴He nucleus, which also appears to contribute to stabilizing many heavier nuclei whose atoms have peaks in consequent abundances of stable elements separated by four mass numbers. This stabilizing effect is augmented by the apparent axial mass balance in the deuteron from having at each apex of the dual equilateral triangle planform one up quark and one down quark. That augmentation of stability by mass balance extends to ⁴He in doubling those same quarks (in alternated sequence) at each apex of the quadruple planform [though there is here an exceptionally large mass loss and release of energy in one step from this reduction of internal linkage interaction of microquanta between quarks within baryons due to increased stretching of these linkages between baryons, per Equation (1) with small negative exponents in the fusion of baryons into larger nuclei (Howard, 2009).]

However, in the deuterons to be controlled for fusions, the proton triangles of quarks and the neutron triangles are necessarily still in separated planes no less than one globule diameter apart in retaining the primacy and strength of their separate p and n baryonic bond systems with more definite contact within each closely linked triplet of quark globules, rather than their coming into a single planform plane with more fully merged globules of both triplets into a true sextet in that one plane. (The same separateness of triplet planes also applies in helium ions.)

Consequently, the mass balance axis of the deuteron is tilted from the axis of triplet symmetry of form orthogonal to its plan reference plane by the 2½ times greater mass (Howard, 2005; Davies and Lepage et al., 2010; PDG reports, 2004, -6, -8, etc.) of the individual common down quark than the mass of the common up quark (with two d as dd and one u in the neutron and the reverse uud in the proton.) Also, the charges of the two positive (+⅔) charges of the lightest up quarks in the proton are offset from the planform plane of bonding symmetry in one orthogonal direction from the plane as well as away from the axis, while the single (+⅔) charged up quark in the neutron is offset in the opposite two directions, whereas the smaller negative (−⅓) charges of the down quarks are oppositely offset in each case (FIG. 1c), resulting in the empiricly rather small, but definite, electric quadrupole moment of the deuteron (Stone, 2000). So an axis of intrinsic spin and related magnetic moment as used in the prior fusion art (Salisbury, 1983a; Kulsrud et al, 1988) for a one dimensional attitude control of fusing ions should not be an ideal exact axis for alignment of charge forces to guide and supplement the strong forces in a quadruple baryon bond. This emphasizes again that the stable balance of the deuteron, as of the proton, as well as their interactions of mass energies and forces, must arise from spins and synchronous orbits of microquanta within the quarks rather than from movement of the quarks within the baryons or spinning of the baryons themselves.

It is relevant that with the prior art's incomplete pre-fusion control of ions in only one spin dimension, using a means for directing the nuclear magnetic moments of two colliding ion beams of D and T nuclei along the directions of their motions, the presumed QM background of the Salisbury invention (1983a) indicated in its description that there should theoretically be obtainable a factor of 10 to 100 or more increase of fusion reaction cross sections compared to that with random ion attitudes in beam collisions. Five years later, with D, T, and ³He ions impacting at various directions in hot plasmas confined in tokamaks or in mirror machines, the Kulsrud et al. invention (1988) predicted fusion enhancement factors (from experimental data available at that time) of only 1.5 to 2 or fusion suppression by means of ion spin alignments (one dimension) parallel, antiparallel, or transverse to the confining magnetic field using an optical pumping or a gaseous spin-exchange alignment method, but without control of impact trajectory directions in the plasma. The Rostoker invention (1990) electrically polarized plasma beams containing similar ions due to separation of ions and electrons, but only for purposes of introduction into a magnetic confinement in which the plasma electrons were “drained away” along field lines, leaving the ions to react without further consideration of polarization alignment effects. In the new 2010 invention herein, with full 3D control in both trajectory angles and ion attitude angles a much greater factor than 2 is expected for increase in fusion output (over the uncontrolled case), or at least 2 for each of the 3 axial dimensions of control, with a minimum total of 2³ (8) compared to randomly oriented ions in colliding beams, especially after empirical tuning optimization. Thus, in the broadest generality of the present invention, its combinations with the generic prior art in technologies contributing to sub-functions in nuclear fusion must include feeding or coupling into other generic reactor components as either additional secondary reactor volumes or as the initial reactor space after 3D preparation of sets of ion attitude angles.

The Body of the Invention

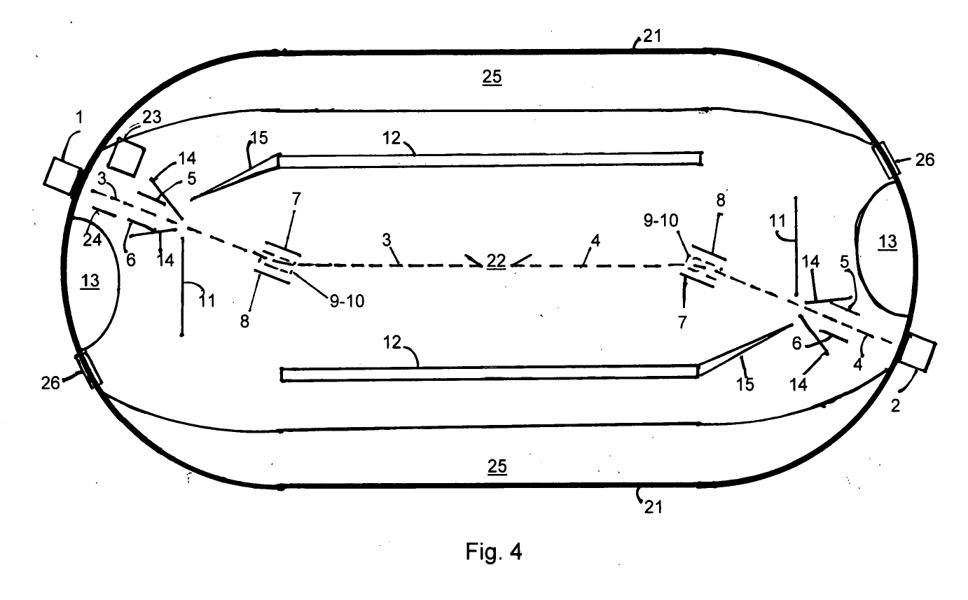

The present invention provides preferably collisions in a hard vacuum of two ion beams which avoid losses of energy that would occur through the presence of any significant amounts of plasma electrons in the reaction space and enable mainly a type of deuterium nuclear fusion reaction that produces only heavier and more energetic nuclear ions (specifically ⁴He) and does not produce wasteful radiation, hot and destructive neutrons, or slow and still energetically wasteful neutrons. This is done by use of resonantly tuned, high energy collisions between deuterium ions in separately accelerated beams aimed against each other with 3D ion attitudes (FIGS. 3a and 3b) controlled principally by the structure of FIG. 4 through electrostatic interactions with a main dipole portion of the small electric quadrupole moment of the ionized deuterium nucleus (the bare deuteron particle.) It is this feature of the method of control of particle attitudes in fusion collisions of particles that is the core of the new generic invention of the arrangement of control structure to provide controlled particle attitudes, as well as of three dimensionally controlled particle attitudes themselves in fusion of particles generally and in fusion of particles in opposed particle beams, and of the new fusion process for the production of the highest efficiency fusion of deuterium nuclei directly to helium four nuclei (with the greatest available release of fusion energy in a single step reaction), which type of fusion or of single-step fusion reaction was not previously feasible on earth (and not relevant in the sun) due to the random diversion of deuterons in hot plasma or uncontrolled beams to production of helium three without critical resonant tuning of individually or collectively controlled energy, trajectory, and attitude of the ions before collision.

This invention is best described by following the process of alignment of parts of the operating structure and physical components required to bring about the desired mutual 3D alignment of velocities and attitudes of any two colliding particles in oppositely directed beams of deuterium ions: In the FIG. 4 block diagram a generic plan view is taken with the top of the vertically held page showing the far side away from the viewer and the bottom of the page showing the near side toward the viewer (used for clarity in this discussion.) There are two generic, separate, variably controllable electric field accelerators 1 and 2 (on the viewer's left and right respectively) from the prior art of static or traveling wave electric field accelerators of bare deuteron positive ions (without accompanying electrons) in initial circularly symmetric pencil beams 3 and 4 of the ions of each accelerator fed into a generic high vacuum chamber 21 of the prior art including suitable vacuum pumps for the scale of operation. (For static accelerators the negative output pole of the accelerator is grounded, and all subsequent field potentials are operating with reference to ground.) With widely controllable and on/off generic switching of ion beam currents from the prior art suitable for the intended power level of operation, the two accelerators generate essentially linear pencil beams 3 and 4 of up to over 1.1 MeV (variable) deuterons to oppose each other for eventual ion collisions across a generic vacuum reaction zone 22 along the center of the generic vacuum chamber 21 (but the beams are not yet aligned coaxially for collisions.)

From its small electric quadrupole moment cited earlier, the deuteron is slightly polar electrostatically. But each ion's spin axis is only nominally or roughly parallel to and somewhat co-directional with or offset from its velocity vector along the axis of a pencil beam of the ions. With two +⅔ charged up quarks and one −⅓ down quark on the proton triangle of the deuteron versus one +⅔ up quark and two −⅓ down quarks on the neutron side of the deuteron leaving the center of the net positive charge displaced toward the proton away from the greater part of the negative charge in the neutron, and with the center of mass oppositely displaced by the heavier down quarks from the geometric center of the deuteron toward the neutron, then the proton halves of the deuterons under electric field acceleration in each beam lead the particles in their forward sides in their roughly opposing directions of linear motion, and the triangle side of the proton with the two +⅔ charges on its up quarks will tend to be ahead of the opposite point of the triangle with its heavy −⅓ down quark masking to a degree the +⅔ charge of the neutron's one up quark on the trailing side. This motion may be or, for least use of input power, preferably is not smoothed within each accelerator by generic collinear magnetic fields generated by fixed or controllable currents in generic coaxial coils of wire or equivalents inside or outside the vacuum chamber. If collinear magnetic fields are present in the linear accelerators used, it is preferable that they be present only near the ion source before the greater portion of the electric acceleration occurs, so that the accelerating field action on the ion electric moments will have the maximum available ion travel time to damp out any undesirable gyroscopic precessional motion of the deuterium ions that is developed in the magnetic field. [Note again that there are two codirectional electric bonds aiding the strong force bonds between the two + quarks in the proton and the two − quarks in the neutron, and on the opposite side of the deuteron that there is a single similarly aiding but reversed-field bond between the single quarks of opposite charges in the two subparticles of each deuteron. (The spins of all particles are taken, as stated earlier, to be primarily the summed spins within the quarks, and under the preferable conditions the magnetic fields of the quarks and particles are neglectable except to note that each beam's ion current sets up a toroidal magnetic field around the beam and that with approximately equalized currents in the two opposed beams these fields will tend to cancel out in the relatively narrow reaction zone 22 along the axis of the cylindrical part of the vacuum chamber 21 where they are both present.)]

In a similar (but reversed) fashion to the main electric polar action, the axis of mass between the forward and trailing baryon subparticles in each deuteron is displaced from the light up quarks toward the pair of 2½ times heavier down quarks in the neutron subparticle. The tilt of these mass axes with respect to the direction of initial linear motion nearly parallel to the primary electric axis of each deuteron is initially at random around the direction of linear motion. The secondary electric polar axis nearly perpendicular to the main axis is in the plane of tilt of the mass axis for each deuteron. Accordingly, a variably controllable field (of about 1% of the just prior acceleration field) between two deflection plates 5 and 6 seen edge on around each beam 3 & 4 with both attractive negative plates 5 on the side of its beam away from the viewer, will roll each deuteron around its mass axis (subparallel to the direction of beam motion) so that the double-bonded side of the deuteron triangle with the two like charges in each subparticle (especially including the two +⅔ charges of the two up quarks in the proton) is oriented generally away from the viewer's position at the bottom of the vertical display of the plan view in FIG. 4 and nearly perpendicular to the beam 3 and 4 velocities out of accelerators 1 and 2. This will turn the beam velocity direction only slightly, and taking the mass axis as the spin axis, should set up little precessional motion. [In the event that in fitting this structure into a particular existing vacuum chamber, or similar installation limitation, deflection plates 5 and 6 are so short along the beam dimension that this rolling of the ions cannot be tuned to a peak effect by this field voltage adjustment without excessive precessional movement of the beam parallel to the plates (as seen on a final fluorescent alignment screen 11), then an additional optional pair of deflection field plates 5a and 6a (not shown) enclosing the beam at 90° to plates 5 and 6 with separate generic controls and a lower range of field DC voltage balanced with respect to ground may be needed to buck out the precession type of deflection as in oscilloscopes.]

Before one beam's (3) leading edge (or optionally after the trailing edge) of plates 5 & 6 on the viewer's left side of the plan a beam of electrons from a shielded accelerator 23 at about 1 MeV variable energy and 100+ times the ion particle density and same beam cross-section as beam 3 or slightly larger is directed across beam 3 toward the viewer's side of the plan to impact and pre-excite the deuterons of beam 3 (but not to the point of breaking the deuteron bonds between its baryon subparticles) without deflecting beam 3 significantly due to the low mass of the electrons and the 4000 times higher mass of the ions. The electrons of this beam are then swept on out of the action by its positive collection plate (relative to its generic cathode) which plate 24 is preferably held at a potential close to that of the nearby deflection plate 6. Alternatively, this means of pre-excitation may be replaced by any equivalent generic high frequency electric field [such as from a wave guide horn antenna or laser light field (preferably at an absorption resonance frequency) narrowly focused on beam 3. Any such field must be absorbable by the conventional protection coating of the interior of the vacuum chamber 21 to avoid metallic reflections and interference with the other beam 4.] (The ions of beam 4 on the right side of the figure remain unexcited and constitute therefore the more stable ion set in the subsequent reaction zone 22 along the center line of the cylindric part of chamber 21.)

Just before the ion beams 3 & 4 reach the center line reaction zone 22 additional long and narrow electrostatic deflection field plates 7 and 8 seen edge on are charged to about 25% (variable) of the initial beam acceleration field to roll the deuterons in both beams around axes through the mass axis and perpendicular to both the present field and the line of prior motion so that the deuterons of beam 3 on the left are quickly oriented with the proton away from the viewer toward the more distant negative plate 7 with the deuterons' two + up quarks facing near the trailing direction within the beam and with the pre-excited single bond straight forward in the direction of motion which is bent away from the viewer station about 20 degrees to travel coaxially with the reaction zone axis 22 through the center of the vacuum chamber The deuterons of beam 4 are rolled oppositely so that each proton is downward toward its attractive negative field plate 7 with the unexcited double bond straight forward and the single bond protected in the trailing position while the direction of motion is bent toward the viewer station about 20 degrees to travel to the left along the central reaction zone axis 22. (These 20 degree deflections of both beams will have gyroscopic angular deflection errors which must be corrected next.)

Since the protons of each set of deuterons would also have a tendency to roll laterally to the intended roll direction a pair of not-so-narrow plates 9 and 10 are arranged around the two beams at 90° to plates 7 and 8 (as in an oscilloscope) with a variably controlled but minimized positive baseline repellent voltage on each of these four plates to prevent either set of beam ions from also rolling in either lateral direction. Furthermore, since the deuterons do have spin 1, the significant angle deflection of about 20 degrees above will have gyroscopic deflection errors which require adjustably tuned correction fields of as much as around 10% of the original acceleration field to be added to each of plates 9 and 10 to bring the actual deflection to the proper 3D angle as described in the last previous paragraph above. The amount of the correction will depend on the dimensions of the deflection plates used. (At this stage of alignment it will be helpful to have two generic, remotely removable, long persistence, phosphorescent display screens 11 at 90° to the expected beam trajectory at each far end of the reaction zone axis 22 to show the beam angular location under the existent set of beam and control conditions. A generic removal relay action will be convenient if this screen alignment tool option is used in initial set-up, preferably with short beam exposures to extend screen life. This will additionally assist in adjustment of positive beam condensation potentials if that optional feature discussed below is added to correct for beam spreading due to beam space charge effects at the tuned control voltage settings. Generic view ports 26 at each end of the chamber 21, preferably with generic replaceable interior clear glass damage covers, would accommodate optional generic remote TV viewing under initial operating conditions.) Note grounded shield cage cone outlines 14.

As the next alignment step, the deflection field potentials on plates 7-10 on left and right are adjusted so that the two beams come into coaxial alignment along center line reaction zone 22. The deuterons of the two beams 3 and 4 then are able to collide at about the deuteron disruption energy, with particles of beam 4 kept just below disruption and those of beam 3 kept just above disruption energy so that their separated subparticles are already positioned to slide directly into position attached to the unseparated subparticics in beam 4 to create helium four nuclei (alpha particles.) This occurs with the three quarks of the beam 3 protons bonded to the viewer's far side of the quarks of the neutrons of beam 4 both electrically and by the strong forces, and with the three quarks of the beam 3 neutrons bonded to the viewer's near side of the quarks of the protons of beam 4 in the same way. These bondings release the increased bonding energy of the helium four particles as their fusion kinetic energy. This also orients the subparticle axes to cancel the summed spins 1 of the deuterons' quarks yielding the observed spin 0 of the helium 4 nucleus. (Use of generic reaction rate instrumentation is assumed.)

At this point an angle of departure from exact collinearity of beams 3 and 4 along the reaction zone axis 22 should be tuned for an additional peak in control of the ion trajectory angle at impact. By increasing the deflection field strength on the left side plates 7 & 8 and decreasing the field on the right hand 7 & 8 the beams will be turned further away from the viewer at about the same total energy with a distinct change in the impact angle of ions in the beams. Since the reaction zone is much decreased in effective volume at the same time, a shoulder or secondary bump in the rate of decrease in the overall reaction rate curve would indicate that the change in ion impact attitude is beneficial, possibly enough that a retuning earlier in the adjustment process might bring that peak into play at the coaxial peak in the reaction zone volume. Reversing the changes between the left and right fields would bring the intersection of the beams closer to the viewer's station in a reversal of the trajectory angle from the coaxial toward the viewer. In the same way deflection plates 9 and 10 to left and right can have their voltages varied to deflect the beams for collisions out of the plane of the plan view. By this process a range of trajectory and attitude impact angles can be investigated for best angular tuning in a research lab installation. The overall range of angles can be varied readily by inserting angled adapter plates between the input port on the schematically rounded ends of the vacuum tank and the particle input accelerators 1 and 2 so that one beam goes more toward the viewer with the other more away from the viewer and tilting the reaction zone accordingly, with changes of locations for the sets of deflection plates and the fluorescent alignment screens beyond the ends of the reaction zone 22. For any of these purposes well regulated generic DC voltage supplies are desirable over the break-in period for each specific design and power level.

Next (preferably) the angular spreading of the ion beams 3 & 4 due to the repulsive forces of their own space charge dilutes the concentration density of ions in the reaction zone 22 and reduces the fusion reaction rate. To counteract this an adjustable (but minimized) positive electric repulsion field in the range of 5% of the original acceleration field is adjusted by a single voltage applied to the 8, 16, or 32 each parallel bars or edges of heavy narrow plates as vanes 12 arranged radially and symmetrically around the reaction zone and parallel to its axis 22 to compress the beams against angular spreading from space charge effects. The wide rectangular or cylindrical openings between these narrow elements 12 permit the radial escape of energetic helium four ions from the fusion reactor zone to the available generic energy extractors 25 with wall protection coatings from the prior art that are shown schematically lining the interior walls of the vacuum chamber 21. The vanes themselves may participate in this energy extraction, and they may erode, requiring materials from prior art and periodic replacement in any type of readily unfastened and refastened supports. This vane field will also have the effect of reducing the ion kinetic energy in the reaction zone before collision. That effect should be carefully tuned to balance any peak in reaction rate versus any losses in radiation of excess energy near the resonant point at which the sum total of ion energy in collision equals the 2.2 MeV (rounded) bond-breaking energy between the proton and the neutron of the deuteron, especially in the pre-excited ions.

It is expected that the unfused deuterium ions escaping the reaction zone 22 between the last deflection plates 7-10 for the beams will be collected and re-utilized by one of the generic kinds of obvious adaptations from the prior art, such as: Energy conservation by energy extractors 13 for the beam residual energy followed by simple collection by vacuum pumps as a gas deionized by contact with vacuum vessel walls and reinsertion into the initial ion guns 1 and 2. Or, turning by magnetic or electrostatic deflection at 13 into a circular orbital reactor such as for instance the Salisbury, 1983a or other device. Or insertion at each end of the primary reaction zone 22 into a pair of field reversal reactors with a shared far point with mutual reflector reversal in an isosceles triangle, etc. To assist in such collections for re-use a ½ cone of extensions 15 (or separately chargeable positive extensions) of the compression field bars or vanes 12 may be optionally added at each end of the vacuum chamber, with the additional use of further protecting and shielding the ion guns 1 and 2, plates 5 and 6, and exciter means 23 and 24. Also, optionally, the narrow end of the full cone shield cages 14 shown in outline may be extended as small diameter beam injector tubes right into the rectangular opening between plates 7-10 at each end of the reaction zone 22; especially when static charge repulsion has been allowed to spread the beam 3 and 4 diameters while crossing the reaction zone, such beam injector extensions will reduce ion damage around the beam 3 and 4 inputs.

The final step of the alignment process is the re-tuning of the various voltages, deflection angles, and length of the collision reaction zone both to maximize the percentages of the beam particles that collide with each other in flight and to maximize the amount of fusion energy that can be most readily collected for controlled use, as well as to adjust out the effects of gyroscopic precession of particles over the particle drift lengths and angle deflections in the fields finally found most suitable in each type of scale, particular installation, and beam ion current of the moment. If the combination of pre-excitation energy and beam 3 acceleration energy can be either minimized or maximized versus the opposite for the total energy of beam 4, it may be possible to adjust the amount of fusion energy that appears in recoil of the resultant helium nucleus with reduction of the possible emission of hard Xrays, if it develops that absorption of that radiation is not a useful form of energy extraction. It is probably unavoidable that some portions of the fusions in glancing collisions will occur as helium three or tritium fusions, possibly with neutron release, and that this may vary with the balancing of collision energy. It is predictable that Xray and neutron emissions can be tuned for if desired and used to replace the generic pre-exciter in large scale models, especially with 4, 6, or multiple dual beam reaction zones not necessarily all in one plane at or adjacent to a common center with or without some shielding of one of every coaxial pair of input beams as part of the pre-exciter. In that case, with a sufficient number and ion density of beams, the effective recapture and fusion of glancing initial collision particles could become a large factor in overall efficiency of this process and beam-by-beam structure. Such a structure and process is far simpler than the tokamak magnetic or laser compressor of high pressure plasma fusion reactors as well as the various fusor/migma types of magneticly compressed lower pressure plasma reactors and point impact compressors by multiple point colliding beams of ions in the prior invented art.

What is claimed is:

1. A method or process and coordinated generic means or basic apparatus that enable direct fusion of two deuterium ions into a ⁴He nucleus for release of unusually augmented fusion energy, a reaction that is not known to occur as a single reaction in nature or in the prior fusion art, constituting a newly invented general type or class of source of nuclear energy.

2. The method, means, and resultant energy source of claim 1 wherein the process and apparatus includes generic ion attitude and/or impact angle control in more than one dimension of the said ions in collision for fusion energy release.

3. The method, means, and resultant energy source of claims 1 and 2, separately or together, wherein the process and apparatus includes generic controlled tuning of the kinetic energies of the said ions in collision for fusion energy release.

4. The generic method and means of claims 1, 2, and 3, separately or together in any combination, wherein other ions, or one other nuclear ion with one deuteron, or any ion and another substance in any gaseous, liquid, or solid state, are reacted for fusion energy release.

5. The generic method and means of claims 1, 2, 3, and 4, separately or together in any combination, combined with any generic means of producing ions to provide a system for fusion energy release.

6. The generic method and means of claims 1, 2, 3, 4, and 5, separately or together in any combination, further combined with any generic means of extracting fusion energy to provide a system for fusion energy application.

7. The generic method and means of claims 1, 2, 3, 4, 5, and 6, separately or together in any combination, further combined with any generic means of additionally confining reactive nuclear particles, whether in plasmas or re-circulating beams, by magnetic fields, combined electric and magnetic fields, inertia or combined inertia and magnetic and/or electric fields, for prolonged or compressed increase of opportunities to react in order to provide an enhanced fusion energy system.

8. The generic method and means of control of subatomic particle attitudes that is the core of the new generic invention, as well as any use of two or three dimensionally controlled subatomic particle attitudes themselves, with or without any prior reactor space technology.
